(19) United States
(12) Patent Application Publication
(10) Pub. No.: US 2004/0133657 A1
(43) Pub. Date: Jul. 8, 2004

(54) Digital media system and method therefor

(75) Inventors: C. Eric Smith, Austin, TX (US); R. Stacey Zuniga, Kyle, TX (US); James E. Butcher, Austin, TX (US); Henry L. Lynn, Austin, TX (US); L. Wayne Walker, Austin, TX (US); Stephen L. Pitman, Austin, TX (US)

Correspondence Address: MUNSCH, HARDT, KOPF & HARR, P.C., INTELLECTUAL PROPERTY DOCKET CLERK, 1445 ROSS AVENUE, SUITE 4000, DALLAS, TX, 75202-2790, US

(73) Assignee: BroadQ, LLC, Austin, TX

(21) Appl. No.: 10/336,060

(22) Filed: Jan. 3, 2003

(51) Int. Cl. G06F 15/16

(52) U.S. Cl. 709/219

(57) ABSTRACT

A digital media system comprises a computer having a local storage device operable to store a plurality of driver applications and being operable to access a remote storage device having stored digital media content via a global computer network, and a digital media player communicably coupled to the computer and operable to access the plurality of driver applications and further operable to receive user commands and access and decode the remote digital media content specified by the user for playing on one or more components of an entertainment system coupled thereto.

### RELATED PATENT APPLICATION

This patent application claims the benefit of U.S. Provisional Application No. ______, entitled “The Gocho Network: A System for the Distribution and Control of Digital Information and Entertainment,” filed on Jan. 3, 2002. This patent application also claims the benefit of U.S. Provisional Application No. ______, entitled “Digital Media System and Method of Operation,” filed on Jul. 15, 2002.

### TECHNICAL FIELD OF THE INVENTION

The present invention relates generally to the field of media entertainment systems and broadcast systems, and in particular to a digital media system and a method therefor.

### BACKGROUND OF THE INVENTION

Entertainment has progressed with the advancement of technology and has been shaped by people's desire to have more control over their entertainment options. Radio broadcasts brought people into the home and gathered them around a little box that brought them sounds from far away places. Later, television added a visual component to that experience. Today's entertainment is gradually moving away from a one-size-fits-all mode of network broadcast to increase the variety of shows available as well as enabling viewers to record and time-shift the programs to a time more convenient for their busy lifestyle. The video cassette recorder (VCR) enabled viewers to program the VCR and record broadcast television shows onto video cassettes. Driving a multi-billion dollar industry, users also purchase or rent movies or other media content recorded onto video cassettes. The newer digital versatile disc (DVD) is a digital form of recording media that is more compact and wear-resistant.

Cable television is another form of broadcast entertainment that uses an infrastructure of cables extending to each viewer's home to deliver the media content rather than over air. The broadcast signal delivered to each home is decoded by a set top box connected to the television set. Because the flow of information in these cables is uni-directional, subscribers of cable television also cannot control the flow of programming to their living rooms. Although cable companies are aiming to provide the video-on-demand service to allow its subscribers to interactively choose the timing and content of the programming, the deployment of this service is slow and deliberate due to the prohibitive cost of laying down bi-directional broadband digital networks.

Satellite broadcast systems use a constellation of geostationary satellites orbiting above earth to transmit digital media signals to the subscribers rather than cables buried in the ground. The direct broadcast satellites beam down a broad spectrum signal to satellite dishes installed on the subscribers' rooftops. A decoder box or receiver decodes the digital data and supplies an analog video and audio signal to the video display and audio system. Satellite companies cannot offer interactive services like video on demand because they lack the continuous two-way connectivity the service requires. Instead, satellite companies offer digital personal video recorders (e.g. SONY TIVO and SONIC BLUE REPLAY TV) and pay-per-view options. Although these services provide its subscribers some interactivity, they do not provide the same degree of choice and control over the viewing experience as video on demand or similar services.

Computer users who have high-speed access to the Internet are able to download digital media content into memory or storage media in their computers. These users are then able to view the downloaded video files on their computer monitor screen or listen to the audio files over the computer speakers. This entertainment experience is far from ideal. Because the computer is typically situated in a study or home office, the seating in front of the computer is typically arranged for one person. Further, the screen size of a computer monitor is typically much smaller than a television set, the audience has to crowd around the monitor within a short distance of the screen. The sound quality of computer speakers is also far inferior than that of most home stereo systems. Because the computer system does not provide optimum viewing or listening experience, the user may opt to purchase special equipment to write the media file content onto a CD or DVD and then play them using their entertainment system. For most users, these factors present obstacles that they are not willing to tackle.

### SUMMARY OF THE INVENTION

It is desirable to provide a system and method to bridge the gap between the computer and the television so that digital media content accessible via the computer can be enjoyed by the users on their home entertainment system. It is preferable that digital media content stored or accessible by the user's computer be easily delivered to the home entertainment system for viewing or listening. Furthermore, such a system preferably is able to stream digital media content directly from a network source, such as the Internet, for playing on the entertainment system.

In accordance with an embodiment of the present invention, a digital media system comprises a computer having a local storage device operable to store a plurality of driver applications and being operable to access a remote storage device having stored digital media content via a global computer network, and a digital media player communicably coupled to the computer and operable to access the plurality of driver applications and further operable to receive user commands and access and decode the remote digital media content specified by the user for playing on one or more components of an entertainment system coupled thereto.

In accordance with another embodiment of the present invention, a digital media system comprises a content provider having a collection of digital media content, a computer system having a storage media having encoded thereon a plurality of driver applications, and a digital media player communicably coupled to the computer system and the content provider via a global computer network and operable to receive user commands instructing the content provider to stream digital media content specified by the user to the digital media player for decoding using a driver application and playing on one or more components of an entertainment system coupled to the digital media player.

In accordance with yet another embodiment of the present invention, a method comprises displaying, on a television, a list of digital media content stored in a remote database, receiving, at a digital media player coupled to the television, a digital media content selection from the list from a user, streaming the digital media content selection stored in the database over a global computer network, buffering the streaming digital media content selection as it is received at the digital media player, and sending the buffered digital media content selection to the television for displaying to the user.

### BRIEF DESCRIPTION OF THE DRAWINGS

For a more complete understanding of the present invention, the objects and advantages thereof, reference is now made to the following descriptions taken in connection with the accompanying drawings in which:

FIG. 1A is a simplified block diagram of a consumer model digital media system according to an embodiment of the present invention;

FIG. 1B is a simplified block diagram of an embodiment of a digital media player according to an embodiment of the present invention;

FIG. 2 is a simplified block diagram of an enterprise model digital media system according to an embodiment of the present invention;

FIG. 3 is a simplified flowchart of an initial configuration process of a consumer model digital media system according to an embodiment of the present invention;

FIG. 4 is a simplified flowchart of a media session process of a consumer model digital media system according to an embodiment of the present invention;

FIG. 5 is a simplified flowchart of an initial configuration process of an enterprise model digital media system according to an embodiment of the present invention;

FIG. 6 is a simplified flowchart of a post-configuration initialization process of an enterprise model digital media system according to an embodiment of the present invention;

FIG. 7 is a simplified flowchart of a secure content delivery process of an enterprise model digital media system according to an embodiment of the present invention;

FIG. 8 is a simplified flowchart of a station load balancing process according to an embodiment of the present invention;

FIG. 9 is a simplified block diagram of a digital media head end according to an embodiment of the present invention;

FIG. 10 is a simplified flowchart of a show saver process according to an embodiment of the present invention;

FIG. 11 is a simplified block diagram of a peer-to-peer model according to an embodiment of the present invention;

FIG. 12 is a simplified message flow diagram of the peer-to-peer process according to an embodiment of the present invention;

FIG. 13 is a simplified flowchart of an anti-hack process according to an embodiment of the present invention;

FIG. 14 is a simplified flowchart of a predictive download process according to an embodiment of the present invention; and

FIG. 15 is a simplified flowchart of a virtual digital content broadcast process according to an embodiment of the present invention.

### DETAILED DESCRIPTION OF THE DRAWINGS

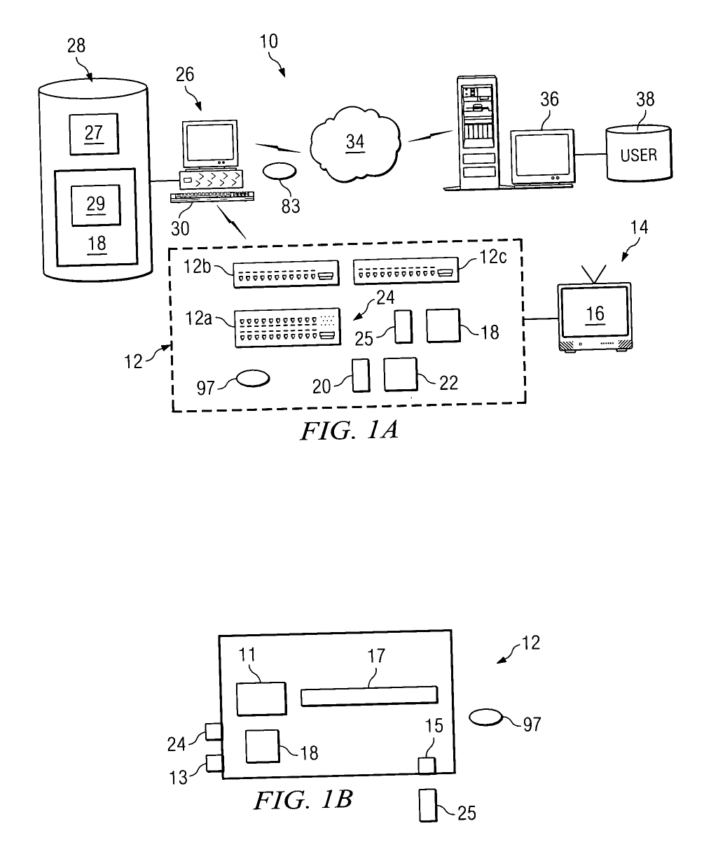

The preferred embodiment of the present invention and its advantages are best understood by referring to FIGS. 1 through 15 of the drawings, like numerals being used for like and corresponding parts of the various drawings.

FIG. 1A is a simplified block diagram of a consumer model digital media system 10 according to an embodiment of the present invention. In this embodiment, digital media system 10 includes a digital media player 12, an entertainment and sound system 14, which typically comprises a television set 16, a computer system 26 in communication with digital media player 12, and a multimedia software 18 residing on the digital media player 12 and preferably on computer system 26.

Referring to FIG. 1B, digital media player 12 comprises any suitable electronic device operable to operate the multimedia software 18 and communicate with the computer system 26 and the entertainment and sound system 14. Digital media player 12 includes a processor 11, a communications port 24 enabling a wired or wireless connection with a computer system 26, and an output port 13 enabling output of digital media content to entertainment and sound system 14. Communications port 24 may comprise any suitable type of data port such as a universal bus port, WiFi, or an Ethernet port. Digital media player 12 further comprises a data reader 15 operable to read and write to a data storage media 25. Data storage media 25 may comprise a removable device, such as a memory card, memory stick, or similar devices. However digital media player 12 may be equipped with a non-removable data storage media (not shown), which may also be employed to store information and media content according to the present invention. Digital media player 12 may further comprise a CD/DVD (compact disc/digital versatile disc) drive 17 operable to read and/or write a CD or DVD, and execute software programs encoded on a CD-ROM 97.

In a preferred embodiment, digital media player 12 comprises a game console 12a, now known or later developed, such as a SONY PLAYSTATION, a MICROSOFT XBOX, a NINTENDO GAMECUBE, and other suitable electronic devices that allow interactive video entertainment applications to be played on entertainment and sound system 14. Such game consoles 12a are typically accompanied by one or more user input devices such as a remote control 20 and a control pad 22. Remote control device 20 may include a plurality of numeric keys as well as keys dedicated to specific functions such as stop, pause, skip, rewind, etc. Control pad 22 is typically adapted for game play and may include directional arrows, a joy stick, and other keys. Other suitable user input devices such as keyboards, voice recognition systems, radio control devices, and personal digital controllers may also be employed.

In another embodiment, digital media player 12 comprises a set-top decoder box, now known or later developed, such as those available from SCIENTIFIC ATLANTA, MOTOROLA, SONY, or other suitable decoder operable to decode digital media content. Set-top decoder box 12b may include a tuner (not expressly shown) that selects individual signals, or channels, from a multicast input signal. Set-top decoder box 12b also generally includes a user input device, such as a remote control to switch between channels, or some other suitable user input device.

In yet another embodiment, digital media player 12 comprises an electronic player 12c, now known or later developed, such as a DVD player, CD player, VCR (video cassette recorder), or other suitable electronic device operable to play content stored on a removable storage media. Electronic player 12c also generally includes a user input device, such as a remote control or some other suitable user input device.

The preferred choice of using a game console such as the PLAYSTATION 2 rather than a custom-made set top box is due to many reasons. One reason is that the game console is well-suited for this application because it is already connected to a television set, which serves as the display device for the game console. A second reason is that there are already multiple tens of millions of such game consoles in the consumers' homes. For example, nearly 50 million PLAYSTATION 2 consoles have been snatched up by game enthusiasts. Another reason is that such game consoles are becoming network-enabled to allow the users to play games online. The confluence of these favorable factors point to a platform based on the game console. However, it should be understood that the present invention is not so limited and such preference is related to the implementation and deployment strategy of the present invention.

Multimedia software 18 operates to network digital media player 12 to computer system 26 and allows a user interacting with digital media player 12 to view and play digital media content 27 residing on computer system 26 or accessible through computer system 26. The user could also access digital media content 27 stored on remote computer systems 26 and storage devices accessible over a network, such as the Internet. In the preferred embodiment, portions of multimedia software 18 reside on both digital media player 12 and computer system 26, however, in at least one embodiment, the multimedia software 18 resides solely on digital media player 12. Multimedia software 18 may be a separate program loaded and operating on the digital media player 12 or encoded into digital media player 12. For purposes of explanation, digital media player 12 and multimedia software 18 may be used synonymously.

Digital media content 27 includes video (moving images often accompanied by audio), audio, image, animation, data, and other forms of digital content. Digital media content 27 may be stored in many formats, now known or later developed. For example, video content can be stored in MPEG (Motion Pictures Experts Group)-1, MPEG-2, and MPEG-4 formats, as well as variations of these formats, such as DivX and QUICKTIME MPEG-4 formats. Multimedia software 18 generally includes specific applications 29 associated with each type of digital media content 27. Each application 29 comprises a program, such as a codec, decoder, or other software program now known or later developed. For example, application 29 may comprise a MPEG-1 codec, a MPEG-2 codec, a MPEG-4 codec, a DivX MPEG-4 codec, a H.264 MPEG-4 codec, a MP3 codec, a WMV (WINDOWS Media Video) codec, a WMA (WINDOWS Media Audio) codec, a QUICKTIME codec, an Email application, an interactive transaction application, a game, or any other suitable executable program. An advantage of at least one embodiment of the present invention is that applications 29 can be network loaded and updated. As a result, the digital media player 12 does not require substantial amounts of memory. Furthermore, some embodiments of the present invention are particularly well suited to execute interactive applications 29, such as transaction based programs, i.e., on-line purchasing, Email programs, and games. In these embodiments, the user can interactively select or input information based on the digital content 27. Applications 29 are generally stored on the computer system 26, the digital medial content station, as described below, or on the digital media player 12.

Television set 16 is typically a part of entertainment and sound system 14 and serves as the interactive video display and sound output system for digital media player 12. Although not shown explicitly, entertainment and sound system 14 typically includes a plurality of speakers and other accessories or components to provide an optimal audio and video environment.

In the preferred embodiment of the present invention, computer system 26 is the user's personal computer system. Computer system 26 typically comprises a processor (not shown), random access memory (RAM) (not shown), and one or more data storage devices 28 such as an internal hard drive, external hard drive, mass storage device, zip drive, networked memory, or another suitable memory system. Data storage device 28 may be logically divided into a plurality of partitions, and further configured to include a plurality of directories. In the consumer model of the present invention, a plurality of digital media content 27 is stored in one or more directories of data storage device 28. The digital media content 27 may include video and audio files in a number of suitable formats. The digital media content may be organized and stored in data storage device 28 according to type of media (images, video or audio), category of content (family vacation 2001, rock music, 80's pop, classical music, Christmas music, action movies, horror movies, Oscar winners, video shorts, etc.) in file directories. Further, a number of media drivers or codecs for reading and streaming video and audio file formats are also stored in data storage device 28. Computer system 26 further comprises one or more user input devices 30 such as a keyboard, a pointer device (mouse, touch pad or the like), voice recognition system, touch-sensitive screen, etc. Computer system 26 communicates with digital media player 12 via a wired or wireless communications or network link 32 using a local area network protocol, such as one of the wireless IEEE (Institute of Electrical and Electronics Engineers) 802.11 protocols, Ethernet, etc. Because a wireless connection may be installed with ease, it is a preferred communication link between computer system 26 and digital media player 12.

Computer system 26 may be further coupled to a global network 34 via a telecommunication device (not explicitly shown) such as a dial-up modem, a cable modem, a DSL (digital subscriber line) modem, satellite modem, or the like. Global network 34 may comprise the Internet, and/or one or more suitable computer networks in which one or more media servers 36 reside. Media server 36 is operable to communicate and access a user database 38 that stores a variety of data associated with users or subscribers of digital media system 10. Furthermore, media server 36 also comprises software application replacements and updates that may be downloaded to computer system 26 and digital media player 12 to ensure continued optimal operations. Global network 34 also comprises a plurality of sources of digital media content from which computer system 26 may download and store in data storage device 28 and then accessing and streaming by digital media player 12 for display on television set 16. Sources of digital media content may include web sites, file servers, email messages, etc. Details of the operations of consumer model digital media system 10 are described below.

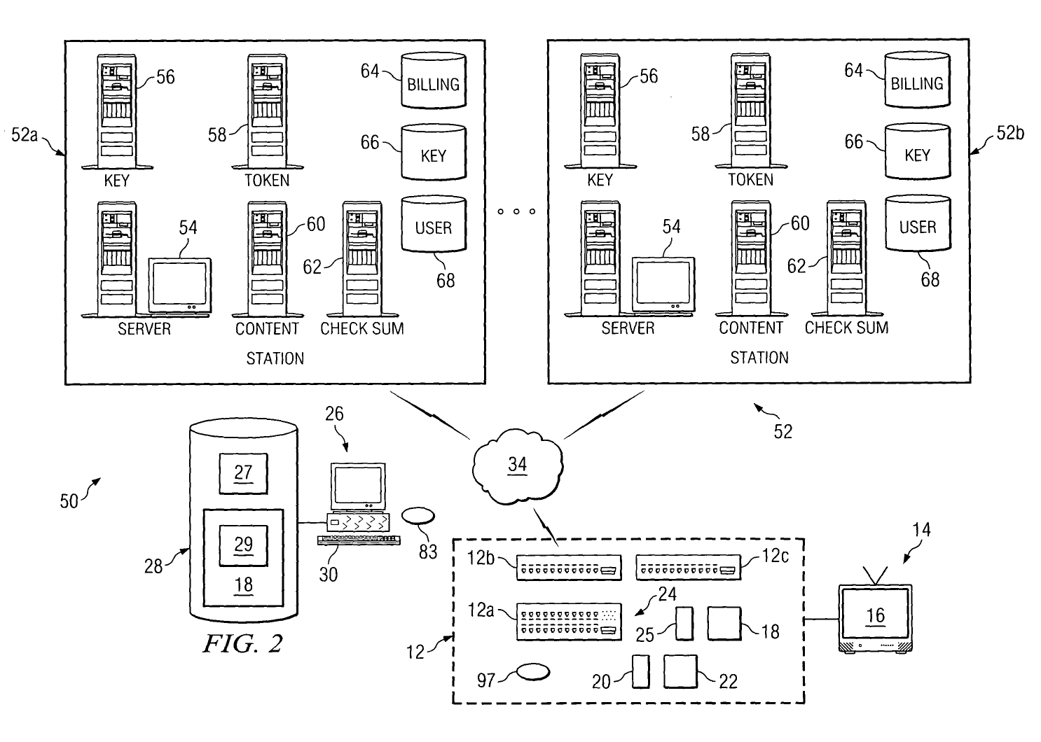

FIG. 2 is a simplified block diagram of an enterprise model digital media system 50 according to an embodiment of the present invention. Digital media system 50 features the transmission or streaming of digital media content via global computer network 34 to a digital media player 12 using multimedia software 18 described in more detail above. In one embodiment, digital media player 12 comprises game console 12a, which may be coupled to the computer system 26, via a network router (not shown) or an Internet modem via a network adapter cable (not shown). In communication with digital media player 12 via global computer network 34 are one or more digital media content “stations” 52. In this embodiment, multimedia software 18 operates as a “tuner” that is operable to access and receive broadcast or targeted transmission of digital media content from digital media content stations 52.

Digital media content stations 52 may be a secured digital media content station 52a or a non-secured digital media content station 52b. Secured digital media content station 52a operates to deliver digital media content to the digital media player 12 in an encrypted or otherwise secured format to reduce copyright piracy. In contrast, non-secured digital media content station 52b operates to deliver digital media content to the digital media player 12 in a non-secured format.

Secured digital media content station 52a preferably comprises a plurality of servers: main server 54, key server 56, token server 58, content server 60, and checksum server 62 each operable to communicate with digital media player 12 and access a billing database 64, a key database 66, and a user database 68. Billing database 64 is used to store data associated with users' usage of the system in order to determine costs that may be billed to each user. The servers may be part of a server cluster or server farm, or their functionality may be performed by a single server, as FIG. 2 may provide a more functional representation of the system. Details of the operation of enterprise model digital media system 50 are described below.

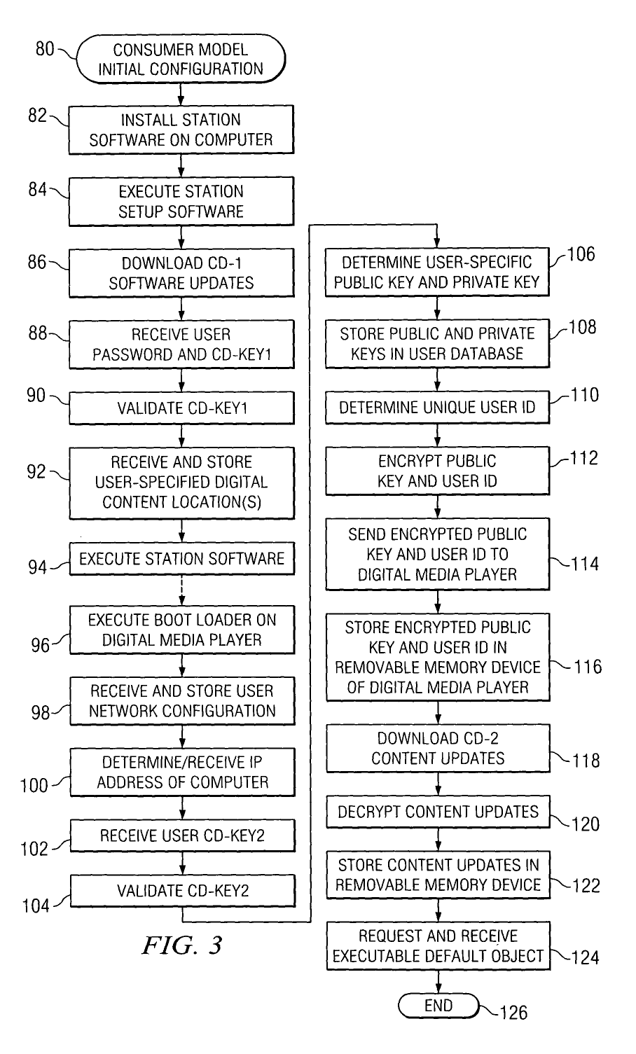

FIG. 3 is a simplified flowchart of an initial configuration process 80 of a consumer model digital media system 10 according to an embodiment of the present invention. References will also be made to FIGS. 1A and 1B. In this embodiment of the present invention, multimedia software 18 will be installed and executed on computer system 26 as well as digital media player 12 so that they may operate as digital media “station” and “tuner” respectively. In block 82, software such as a setup software application encoded on a digital media such as a CD, CD-1 83, is installed on computer system 26. The installed setup software is then executed, as shown in block 84. The setup software downloads software updates that are more current than software encoded on CD-1 onto computer system 26, as shown in block 86. As part of the registration process, the user is also prompted to enter an email address, a unique user password and a factory-assigned unique CD-I key that is printed on the packaging or envelope that enclosed CD-1. The user password and associated CD-1 key are received and transmitted to media server 36, where it is validated and saved in user database 38, as shown in blocks 88 and 90. As part of the registration process, a code word is generated and sent by media server 38 to the user at the email address supplied by the user. The user is further prompted to enter a specification of the location of the digital media content on data storage device 28, which is stored, as shown in block 92. For example, the user may provide the path to the directory or directories where digital media content is stored. Thereafter, the station software application is executed, as shown in block 94, and may operate in the background on computer system 26.

Thereafter in block 96, initial configuration of multimedia software 18 on digital media player 12 to operate as a digital media content tuner begins by loading a CD 97, CD-2, into the CD drive of game console 12a. A boot loader software application encoded on CD-2 is executed in digital media player 12. The user is prompted to enter the network configuration settings, as shown in block 98. For example, the user may select either DHCP (dynamic host configuration protocol) or enter a fixed IP (Internet protocol) number, subnet and gateway for the home network. In addition, the user may be prompted to enter an IP address of computer system 26, as shown in block 100. The user is also prompted to enter a factory-assigned CD-key, CD-key2, printed on materials accompanying CD 97. The CD-key is transmitted, received and validated by media server 36 and stored in user database 38, as shown in blocks 102 and 104. The CD-key may be a case-sensitive alphanumeric string of a predetermined length.

In a particular embodiment, media server 36 also determines a pair of random public key and private key for the user, as shown in block 106. Although asymmetric encryption using public and private keys are described herein, other equally secure or more secure encryption methods may be used. The public key for the user is then stored in user database 38 with other data associated with the user, as shown in block 108. Media server 36 further determines a random user identifier (ID), which is encrypted along with the user's private key and transmitted to digital media player 12 via computer system 26, as shown in blocks 110-114. The encrypted user-specific private key and unique user identifier are stored in the data storage device 25 of digital media player 12, as shown in block 116.

In block 118, updates for multimedia software 18 are downloaded to digital media player 12 and stored on data storage device 25. Digital media player 12 then requests for and receives an executable default object from media server 36, as shown in block 124. The default object comprises software code for the menus, play list editor, media drivers, etc. and is executed on the digital media player. The process ends in block 126.

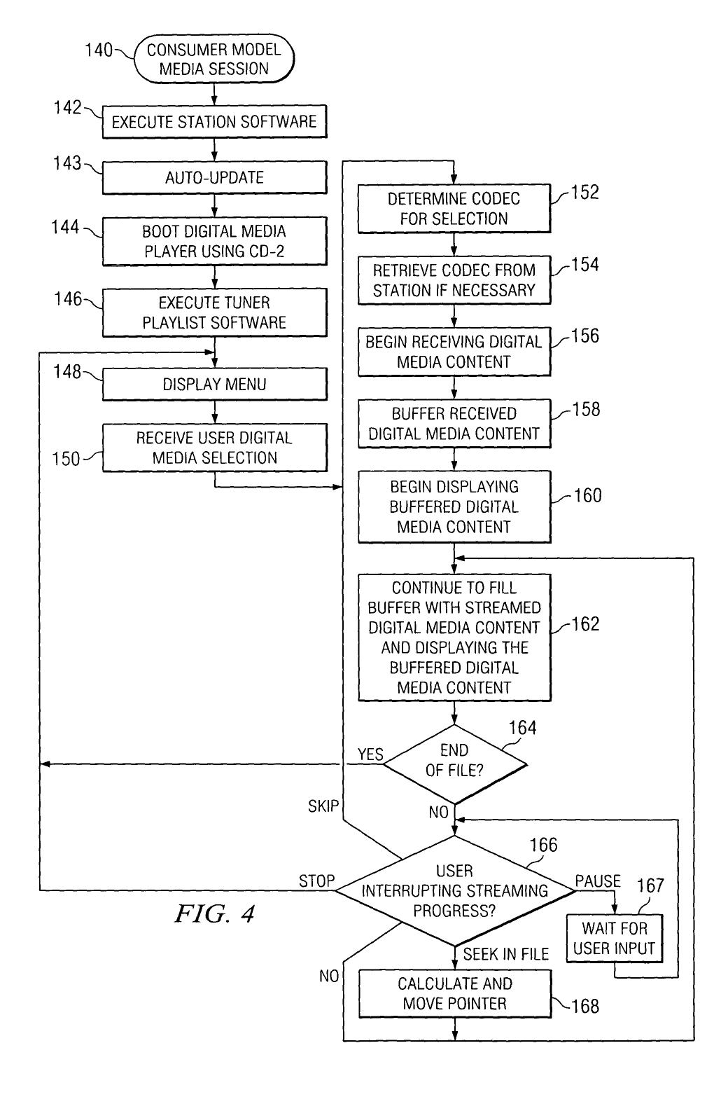

FIG. 4 is a simplified flowchart of a media session process 140 of a consumer model digital media system according to an embodiment of the present invention. The digital media station software should be running on computer system 26. If not, it is executed, as shown in block 142. The media station software then automatically receives updates from media server 36 for code that has a newer version. Digital media player 12 is also booted with CD-2 97 and the tuner playlist software application is executed, as shown in blocks 144 and 146. The tuner playlist software displays a menu on television set 16 for the user to select a variety of options, as shown in block 148. For example, the menu may list images, music, and video as selectable options. As the user selects a type of digital media, a listing of the directory that was previously-specified by the user as containing the type of media is displayed on television set 16. The user is able to browse selected directories to locate, select, and view the meta data associated with each digital media content. The meta data associated with each digital media file may include the title, artist or actor names, the type of music or video, the movie or television show rating, and a brief introduction or description. The user is then able to pick a particular digital media content selection for viewing or playing. This selection is received by digital media player 12, as shown in block 150. In response to the user digital media selection, digital media player 12 determines the necessary application 29 to play the digital media content 27, as shown in block 152. For example, if the user selects an MPEG (Motion Picture Expert Group) 2 video, application 29 is downloaded to read and stream the video file from database 28 of computer system 26 and decode it to play it on television set 16. If an audio file of the type MP3 (MPEG layer 3) or Ogg Vorbis format is selected by the user, for example, then an MP3 or Ogg Vorbis application 29 is needed. The needed application 29 is retrieved from computer system 26 if necessary, as shown in block 154. For example, if the user played a video, and then picks another video at the completion of the first video, then the necessary application 29 is already resident in digital media player 12. However, if the second digital media selected by the user is of a different type, then digital media player 12 retrieves the proper application 29 from computer system 26. Game console 12a typically does not comprise large data storage capacity, so the memory capacity of computer system 26 is preferably used to store the applications 29 and digital media content 27.

Digital media player 12 begins to receive digital media content 27 from computer system 26 over communications link 32, as shown in block 156. A predetermined amount of received digital media content 27 is buffered at the digital media player end before the data is sent to entertainment and sound system 14, as shown in blocks 158 and 160. This buffering causes only a slight delay from the time the user selects the digital media content 27 and when the selection is played for viewing or listening. Because digital media player 12 continues to receive the digital media content 27 from computer system 26 and buffers the received content at a faster rate than data is displayed or played, there is always an amount of digital media content 27 in the buffer, as shown in block 162. If data transmission is disrupted temporarily for any reason, there is sufficient amount of data in the buffer for continuous and uninterrupted display until communication is re-established and data is again streaming from computer system 26 to digital media player 12. This process continues until the end of the digital media content file is reached, as determined by block 164. If the end of the file has been reached, then execution proceeds to block 148, so that the menu is again displayed. If the end of file ahs not been reached, but the user has enter an input that interrupts the data streaming process, as determined in block 166, then the user's input, such as fast forward, skip, pause, and rewind is processed. For example, if the user's input is “stop,” then execution proceeds to block 148 so that the user may pick another digital media selection. If the user input is “skip,” then execution proceeds to block 152 to determine an application 29 for the selection. If the user input is “pause,” then video display is halted with a frame in the display and execution waits for further user input, as shown in block 167. If the user input is an input that navigates within the current media file such as fast forward, rewind, etc., then the media file is traversed and a pointer pointing to the current location in the media file is moved to the appropriate spot, as shown in block 168. If the user has not made any input that interrupts the streaming process, then streaming continues in block 162. As described above, the user may provide input to digital media player 12 using remote control 20, control pad 22 or any other suitable control devices. Further, an on-screen control panel may be displayed on television set 16 that the user may select by using directional arrows on a control device, for example, or some other suitable means.

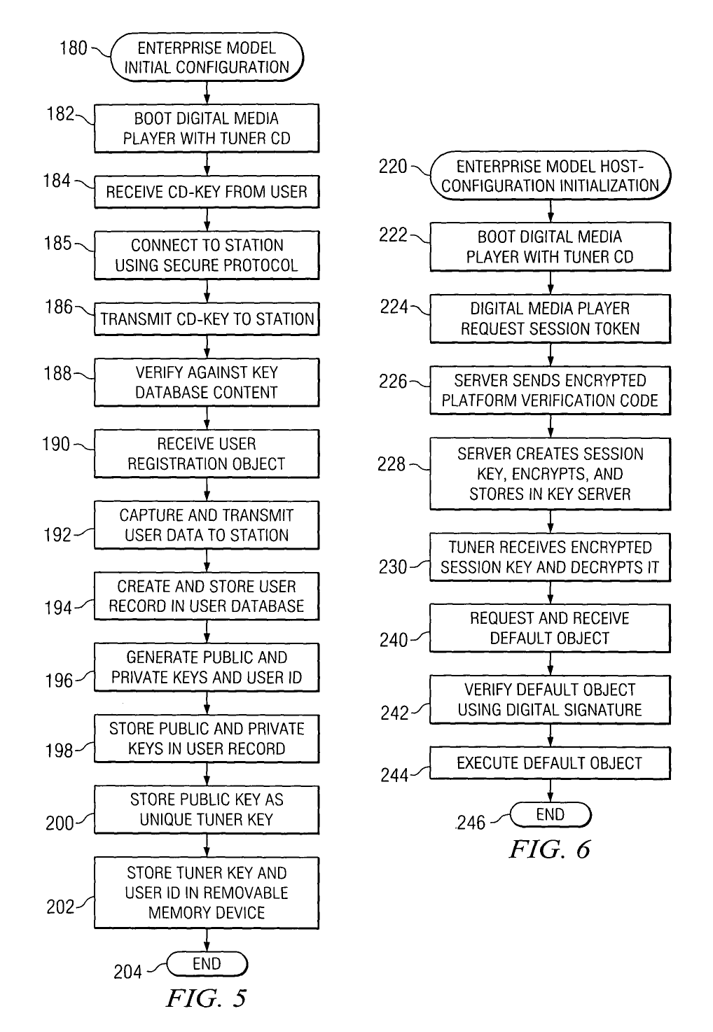

FIG. 5 is a simplified flowchart of an initial configuration process 180 of an enterprise model digital media system according to an embodiment of the present invention. References will also be made to the simplified block diagram of the system shown in FIG. 2. Enterprise model digital media system 50 differs from consumer model digital media system 10 in the storage location of digital media content 27. In consumer model digital media system 10, the digital media content 27 is stored locally on a computer system 26 co-located with digital media player 12 where a local area network and the like is used as the communications link therebetween. In enterprise model digital media system 50, the digital media content 27 is stored at one or more servers that may service many digital media players that communicate with the servers via global computer network 34 or another longer distance network. In digital media system 50, provisions are made to deliver digital media content 27 in a secured manner. The initial configuration process 180 begins by booting digital media player 12 with CD 97, as shown in block 182. The user is prompted to enter the unique factory-assigned CD-key printed on materials associated with CD 97, which is transmitted to a “home” secured digital content media station 52a via a secure connection such as SSL (secure socket layer), as shown in blocks 184-186. The home station is a secured digital media content station 52a that was either previously-designated according to the CD-key or is dynamically-assigned according to some predetermined factors. The factors used to determine the station assignment may include geographic proximity, traffic conditions on the global computer network, the current load distribution of the plurality of stations, and the like.

Secured digital media content station 52a verifies the CD-key by checking it against entries in key database 66, as shown in block 188. Upon verification, secured digital media content station 52a is prompted by digital media player 12 to send a registration object to digital media player 12, which is received thereby, as shown in block 190. The registration object captures and sends user data, as needed, to secured digital media content station 52a to establish a user account for the user, as shown in block 192. User data is combined with the CD-key and the unique MAC ID (media access control identifier) associated with digital media player 12 to create a user record in user database 68 for the user, as shown in block 194. Key server 56 then generates a user-specific and unique private and public key pair, as shown in block 196. The generated public and private key pair is stored in user database 68, as shown in block 198. The user's public key and the user identifier are then sent to digital media player 12 via an encrypted connection using a protocol such as SSL, and stored in data storage device 25 of digital media player 12, as shown in blocks 200 and 202. The user's public key will be used as the tuner's unique tuner key for future communications with the station. The initial configuration process ends in block 204. The user may proceed to the post-configuration initialization process described below.

FIG. 6 is a simplified flowchart of a post-configuration initialization process 220 of an enterprise model digital media system 50 according to an embodiment of the present invention. References will also be made to the simplified block diagram of the system configuration shown in FIG. 2. In block 222, the user boots digital media player 12 with CD 97 and a communication link is made to secured digital media content station 52a. Digital media player 12 then requests a session token from secured digital media content station 52a, as shown in block 224. The server then sends an encrypted platform verification code, as shown in block 226. The encrypted platform verification code may be decrypted with the unique tuner key, the unique hardware IDS and a user PIN. Secured digital media content station 52 then creates a session key, encrypts the session key with the public key of the user and stores the session key in the key server, as shown in block 228. The encrypted session key is incorporated into a session token and sent to the tuner. The tuner receives the session token, decrypts it with its private key, and extracts the session key, as shown in block 230. The session key will be used to encrypt blocks of digital media content 27 being transmitted from secured digital media content station 52 to digital media player 12 operating as a tuner. Digital media player 12 then requests and receives a default object executable only by digital media player 12 from secured digital media content station 52, and verifies the received default object using digital signature using the user's private key to decrypt the encrypted digital signature, as shown in blocks 240 and 242. The default object is then executed, as shown in block 244. The post-configuration initialization process ends in block 246.

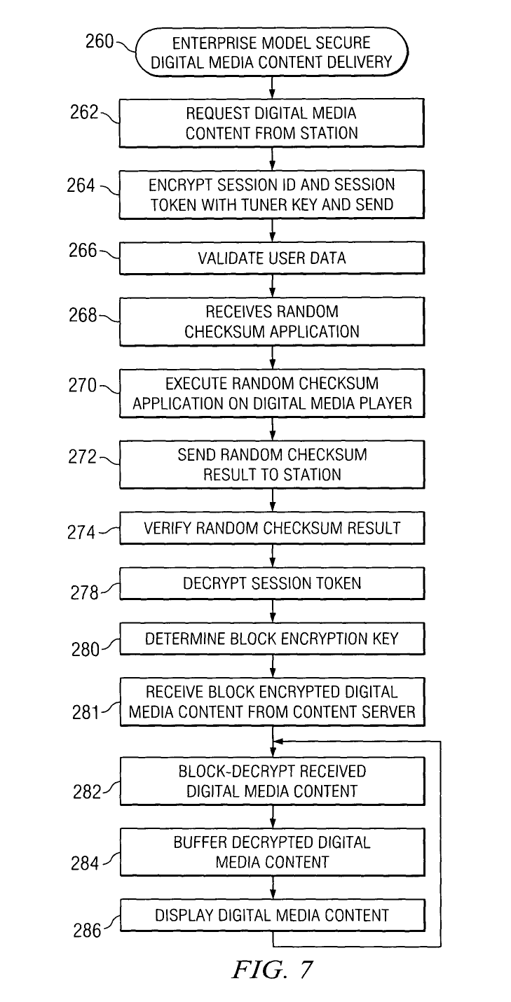

FIG. 7 is a simplified flowchart of a secure content delivery process 260 of an enterprise model digital media system 50 according to an embodiment of the present invention. References will also be made to the simplified block diagram of the enterprise model digital media system shown in FIG. 2. Digital media player 12, upon receiving selection input from the user, requests a digital media content selection in the form of a content object from secured digital media content station 52a, as shown in block 262. Along with its request, it also sends the session ID and session token encrypted with its public key to secured digital media content station 52a for validation, as shown in block 264. Secured digital media content station 52a checks the user's record in user database 68 to verify what was received from digital media player 12, as shown in block 266. Secured digital media content station 52 also generates and sends to digital media player 12 a random checksum native application for execution on digital media player 12. For example, a checksum application server (not shown) associated with station 52 may generate or supply secured digital media content station 52 the checksum native application. The checksum application is received by digital media player 12 and is executed therein to generate a result, as shown in blocks 268 and 270. The result generated by the checksum application is then returned to secured digital media content station 52a, which verifies the result against an expected and known result, as shown in blocks 272 and 274. If the result matches the expected result, then content server 60 downloads the appropriate application 29, which includes a decryption program, and begins streaming the selected digital media content 27. Details of the random checksum anti-cloning and anti-piracy process is described in more detail below.

Digital media content 27 is transmitted using an encryption object, which block-encrypts the requested digital media content 27 using the session key referenced by the session token. Block-encryption is a process by which the content of a file is encrypted in blocks of predetermined size rather than encrypting the entire file as a whole. As a block of data is received by digital media player 12, it may be decrypted without waiting for the entire file to arrive. Digital media player 12 decrypts the session token using its private key to obtain the block-encryption session key, as shown in blocks 278 and 280. Digital media player 12 and application 29, upon receiving each block of encrypted file content, decrypts it, as shown in blocks 281 and 282. The decrypted data is buffered and displayed on entertainment and sound system 14, as shown in blocks 284 and 286. The secure content delivery process continues until the end of the file has been reached or until the user interrupts the session.

In a particular embodiment, digital media content 27 from digital media content station 52 is cached on computer system 26 prior to being streamed to digital media player 12. In this manner, variations in the delivery bandwidth between the digital media content station 52 and the enterprise model digital media system 50 will not negatively affect the user's entertainment experience. For example, the download speed of a cable modem varies with time and cannot be depended upon to deliver a minimum download speed. In this example, the download speed can be sampled to determine the quality of service and the amount of caching that will be needed to provide adequate service. In the case of encrypted digital media content 27, the cached content remains encrypted at all times and cannot be easily decrypted on computer system 26.

Operating in this manner, the digital media content is delivered in a secure manner. Anti-piracy and anti-cloning measures are built into the system architecture. Because digital media content 27 is block-encrypted, digital media content 27 may be displayed as soon as a subset of the blocks has been received and decrypted without waiting for the entire file to be received and decrypted. Further, block encryption and decryption can be performed faster than encrypting or decrypting the entire media file. Although block encrypting and decrypting has been described, other forms of secured content delivery, whether known or later developed, may be utilized to deliver digital media content 27 securely to digital media player 12.

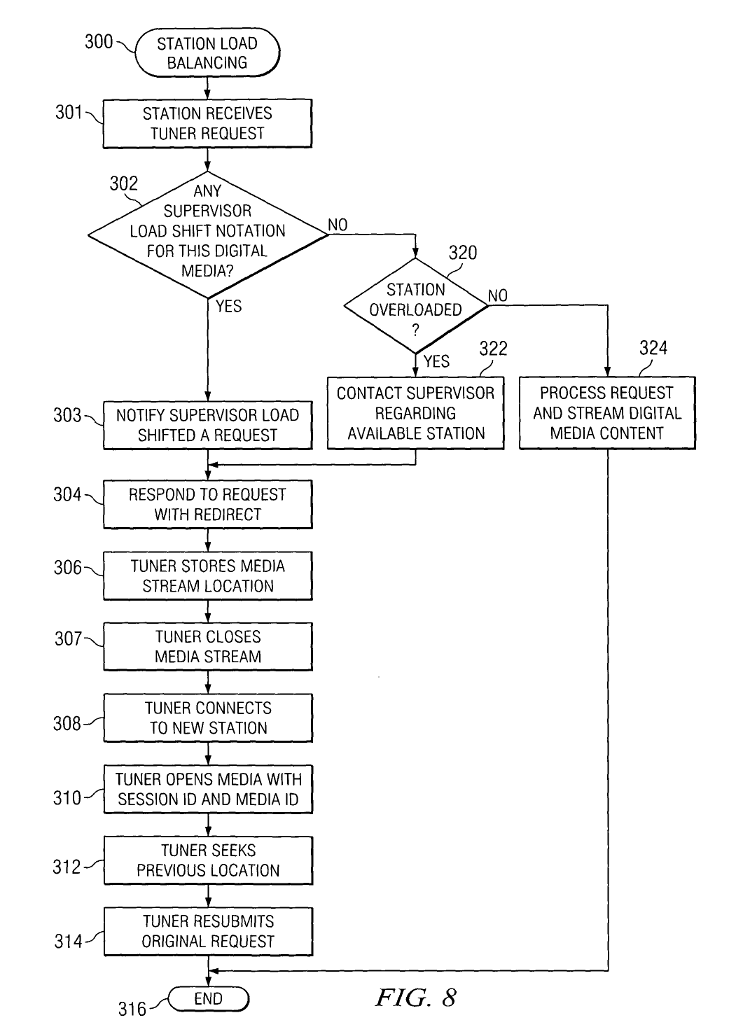

FIG. 8 is a simplified flowchart of station load balancing process 300 for enterprise model digital media system 50 according to an embodiment of the present invention. Process 300 describes what is taking place at two independent digital media content stations 52. A digital media player 12 is assigned to a “home” digital media content station 52 when it first registers. However, the various digital media content stations 52 may shift the responsibility of servicing selected digital media player(s) 12 in order to balance the load among the digital media content stations 52. In block 301, digital media content station 52 receives a request from a tuner to stream a particular digital media content. If there is a notation to deny service from a supervisor application, as determined in block 302, the supervisor application is notified that a request for the particular digital media content has been transferred to another station, as shown in block 303. The supervisor application may be provided an identifier of the station that the denied request has been transferred. Therefore, the request is responded with a redirect, as shown in block 304. The tuner then stores the mid-point location of the media content where streaming has stopped and closes the media stream, as shown in blocks 306 and 307. The tuner then connects to a second digital media content station 52 (station B) specified by the first station, as shown in block 308. In particular, the tuner opens the media session by providing the new digital media content station 52, the session ID, and media ID of the current session, as shown in block 310. The session ID provides an identification of the user as well as the keys necessary to encrypt and decrypt the content transmitted between the digital media content station 52 and the tuner. The media ID provides an identification of the digital media content that was in the process of being streamed to the tuner from the first station. The tuner then seeks to the mid-point location in the digital media file, as shown in block 312. The tuner then sends a request to the second station to stream the digital media content, as shown in block 314. The process continues until the tuner receives the rest of the digital media content from the second station or one or more other stations.

If there is not a previous notation from the supervisor application to deny streaming the requested digital media content, as determined in block 302, then a determination is made as to whether digital media content station 52 is currently overloaded in block 320. Digital media content station 52 may make this determination based on a number of predetermined metrics and analyzed by one or more algorithms now known or later developed. Alternatively, the determination may be made by a station supervisor application which may reside on a different server. In one embodiment, there may be a central control station to which all the digital media content stations 52 send status or operating reports including the load levels at which each digital media content station 52 is operating.

If digital content media station 52 is overloaded, as determined in block 320, then supervisor application is contacted to specify a digital media content station 52 that is available to accept the load, as shown in block 322, and then the request is responded with a redirect with a specification of the available digital content media station 52, if applicable, as shown in block 304. The process may continue as described above at another station. If digital media content station 52 is not overloaded, then the tuner request is processed normally to stream the requested digital media to the user at the location where streaming had stopped, as shown in block 324. The process ends in block 316.

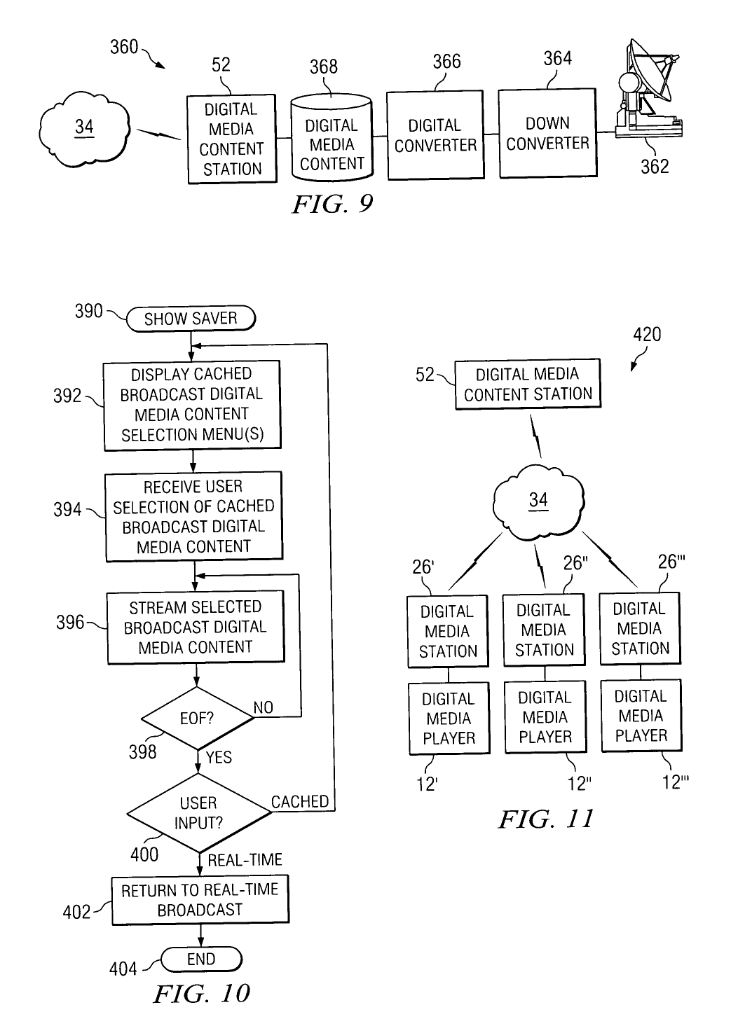

FIG. 9 is a simplified block diagram of a digital media head end 360 according to an embodiment of the present invention. Digital media head end 360 may comprise a satellite dish transmitter/receiver 362 or other suitable receiver communicably coupled to a down converter 364, which is communicably coupled to a digital converter 366. Digital converter 366 is communicably coupled to a database 368, which is coupled to one or more digital media content stations 52. Satellite dish transmitter/receiver 362 is operable to receive transmissions from one or more geosynchronous satellites (not shown) orbiting above earth. Down converter 364 is operable to convert the frequency of the received satellite signal to a lower intermediate frequency that is then converted to digital signals by digital converter 366. Digital media content 27 is then stored in digital media content database 368 for access by content server 60 in digital media content station 52. It is preferable to store at least one week of programs broadcasted on one or more channels to the users.

FIG. 10 is a simplified flowchart of a show saver process 390 according to an embodiment of the present invention. In block 392, a menu of cached broadcast digital media content selections is transmitted by digital media content station 52 to digital media player 12 and displayed to the user on television set 16. The menu may organize the cached broadcast content by channel and time, for example, or a manner that facilitates searching by the user. The user can page through lists of cached content and select the desired program, as shown in block 394. The user may also be able to enter the name of the program to immediately select the desired cached content. The user's input is then transmitted to station 52 and used to retrieve the cached digital media selection from database 368. This cached digital media content 27 is then streamed to the digital media player of the user, as shown in block 396, until the end of the digital media content file is reached, as determined in block 398. Upon reaching the end of the file, the user is either returned to real-time broadcast (block 342) or to the cached content menu depending on the user's input determined in block 400. The process ends in block 404. Although details of encryption, decryption, and other transmission and security details are not shown and described herein, such processes may be employed.

Broadcast television viewers often find out about a program only after it has been broadcast. They may learn about it from friends and family that did view the program and recommend it. With conventional broadcast systems, once the show has been broadcasted, it is too late for the user to view it. Show saver process 390 enables a user to view a broadcast program that has already been aired. The user does not need to know about the program or its broadcast time or channel ahead of time or at the time of broadcast in order to prepare to record or view the show. Digital media content station 52 has access to broadcasted media content of the previous X number of days or weeks so that the user may view a listing thereof and select it for viewing.

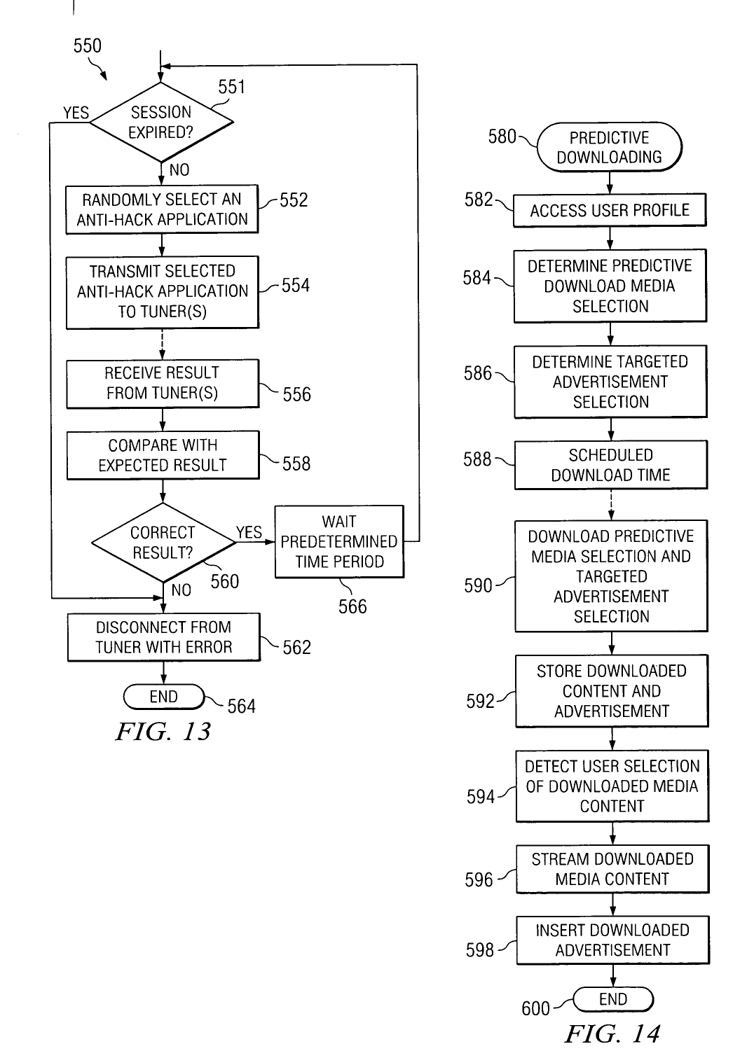

FIG. 11 is a simplified block diagram of a peer-to-peer operating model 420 according to an embodiment of the present invention. Peer-to-peer operating model 420 enables multiple consumer users operating in accordance with the model shown in FIG. 1 to share digital media files stored in their respective digital media stations 26′, 26″, and 26′″. Coupled to digital media stations 26′-26′″ are respective digital media players 12′-12′″, the details of which are described above with reference to FIG. 1. Digital media stations 26′-26′″ may communicate with each other via global computer network 34 or some other wired or wireless networks and share digital media files or portions of the files stored in their respective memory storage devices. The details of the operations of peer-to-peer model 420 are set forth below with reference to FIG. 13.

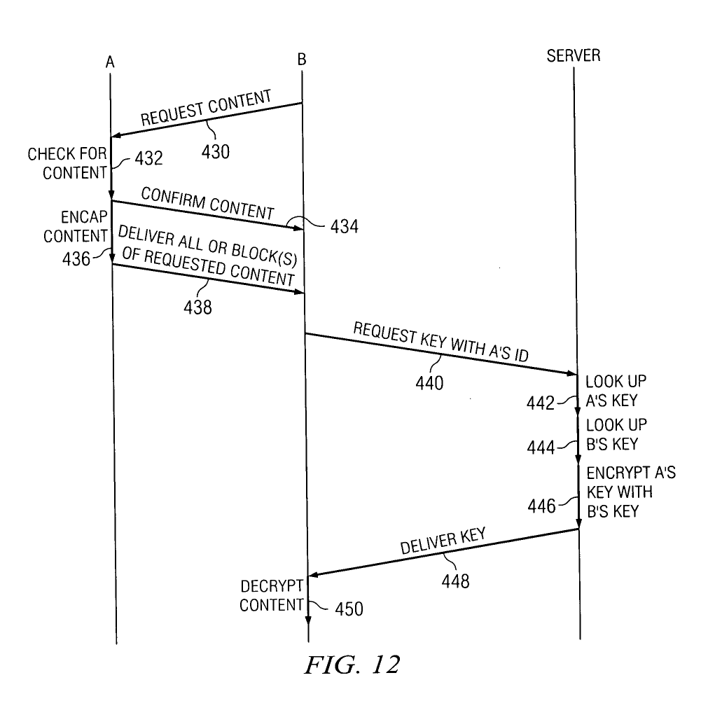

FIG. 12 is a simplified message flow diagram of a peer-to-peer process according to an embodiment of the present invention. User B's digital media system may communicate with user A's digital media system via the Internet or some other wired or wireless networks. User B's system may send user A's system a request 430 for a specific digital media file or specific portions/blocks of a digital media content file. User B may have previously specified a digital media file for streaming or the digital media content may have been selected based on user B's profile or preferences. User B's digital media system communicates with user A's digital media system by using a predetermined message format or protocol, described below. The message format may include an identifier of the digital media system, an identifier of the sender of the message, and a specification of the digital media file requested. In response to user B's request, user A's system checks its stored digital media content or an index thereof to determine whether it has the requested file (432). If it has the requested digital media content 27, then it sends a message 434 back to user B's system to confirm that it has the requested digital media content 27. Otherwise, it sends a message (not shown) to user B's system to indicate that it does not have the requested digital media content 27 and the communication therebetween may terminate. User A's system may then encapsulate the requested digital media content 27 according to a predetermined protocol (436) prior to sending the encapsulated data to user B's system. A protocol according to the teachings of the present invention is an encapsulated data delivery protocol having the following format for the header shown in the table below:

| Byte | Information |
|---|---|
| 1-8 | ASCII representation for name of |
| | protocol |
| 9-10 | binary representation of packet |
| | number in current series |
| 11-12 | binary representation of total |
| | number of packets in current series |
| 13 | encoded representation of packet |
| | content |
| 14 | binary value indicating length in |
| | bytes of the public key |
| 15-30 | ID for current packet series |
| 31-127 | binary representation of public key |
| | of source system |
| 128-224 | binary representation of public key |
| | of destination system |
| 225-241 | binary value of number of bytes that |
| | follow in the data portion of the |
| | packet |
| 242-258 | checksum for the data in the packet |
| 259-X | data content |

Byte 13 contains an encoded representation of the type of encapsulated content in the packet. For example, the most significant bit (MSB) may be used to indicate whether the digital media content 27 is encrypted. The second MSB may be used to indicate how the digital media content 27 is encrypted, for example, using the public key of the destination or using symmetric encryption with the key in the public key of the destination. The six least significant bits (LSB) may be a binary number used to represent the type of data in the data content field of the packet. For example, this field may indicate that this is a request for digital media content 27, a reply to a digital media content request, or the digital media content file.

This protocol allows for a store-and-forward protocol, which can guarantee the delivery of digital media content 27 while protecting its integrity during storage and transport. The protocol enables traceable and secure delivery of digital media content 27 between any two users of the system. The header is used to identify the source and destination of the data payload. A trailing footer may be used to designate the end of the data payload and may optionally identify the next data packet in a series.

User A's system then sends the data packets containing the digital media content to user B's system in one or more data packets (438). User B may send a request to server 52 for A's public key so that it may decrypt the received packet or packets (440). Server 52 then looks up A's public key in its user database (442), looks up B's public key in the database (444), and uses B's public key to encrypt the packet (446). The key is then sent to user B's system, which uses its own private key to decrypt the data and obtain A's public key to decrypt the digital media content 27 (448). B's system may then store the decrypted digital media content 27 for streaming to digital media player 12, which sends the content to the entertainment and sound system 14.

User B may obtain blocks of digital media content 27, from more than one peer system and will decrypt the blocks using the appropriate user system's key obtained from the server. Alternatively, the blocks of digital media content 27 may reside in B's system storage encrypted until all the blocks have been collected and ready for decryption and streaming. B's system may then request the appropriate keys from server 52.

FIG. 13 is a simplified flowchart of an anti-hack process 550 according to an embodiment of the present invention. Anti-hack process 550 is employed to defeat hackers who may attempt to abuse the system by emulating a legitimate digital media player 12. Anti-hack process 550 may take place during normal system operations at random times and begins in block 551, in which the current streaming session with tuner is checked to determine whether it has expired. If the session has expired, then process 550 is not carried out, and execution is skipped to block 562 to disconnect from the tuner. Otherwise, an anti-hack application is randomly selected from among a collection of similar applications that produce different results known to the digital media station 12, as shown in block 552. These anti-hack applications are very small applications that execute quickly to produce results that are seemingly random. The derivation of the result may be dependent on specific setup, configuration, or some property of the digital media player 12. The selected anti-hack application is sent to the digital media player 12, as shown in block 554. The digital media content station 52 may transmit the same anti-hack application selection to all the digital media players 12 having a streaming session currently, or may transmit different anti-hack application selections to the digital media players 12. The digital media player 12 then executes the received anti-hack selection and generates a result. In block 556, the digital media content station 52 receives the anti-hack application execution result from the digital media player 12. The received result is then compared with the expected result, as shown in block 558. If the received result is not the same as the expected result, then the digital media player 12 is suspected as an emulator and one or more predetermined actions may be carried out. For example, a warning statement may be issued to the digital media player 12 and displayed to the user before the session is terminated. Further, data associated with the user, the user's equipment, etc. may be collected for future actions such as research, auditing and/or legal action. If the received result matches the expected result, then the process may return to normal operations of a predetermined duration or a time duration that is selected at random, as shown in block 566, before anti-hack process 550 is repeated. Operating in this manner, this anti-hack process may be repeated a number of times to continuously confirm that the user is a legitimate user of the system.

FIG. 14 is a simplified flowchart of a predictive download process 580 according to an embodiment of the present invention. Predictive download process 580 is a process by which the added available bandwidth at off-peak times is used to download or push digital media content selections 27 that users may desire before such selections are actually picked by the users. Predictive downloading attempts to predict which digital media content 27 certain users may desire based on a number of factors such as user surveys, user profile (age, sex, geographic region) and demographics, past digital media content selections, analyses of patterns of past digital media content selections, etc., as shown in block 582. Based on this user information, digital media content 27 is selected, as shown in block 584. Predictive downloading further uses this information to select targeted advertisement of goods and services that are more relevant and appealing to the user, as shown in block 586. Each advertisement is associated with meta data that indicate the demographics, time of day, geographical location, and frequency of play for the advertisement. A schedule for downloading the selected digital media content 27 is determined, as shown in block 588. The digital media content 27 is then streamed to the user's computer and stored therein at the scheduled time prior to any instruction from the user, as shown in block 590. The digital media content 27 is stored on the user's computer, as shown in block 592. A menu selection may enable the user to select predictive download digital media content 27, as shown in block 594. The digital media content 27 is then streamed to the digital media player 12 and shown on the television 16 or downloaded targeted advertisement is inserted at appropriate intervals, times and frequency, according to the meta data of the advertisement, into the digital media content 27 showing, as shown in blocks 596 and 598. The process ends in block 600.

The predictive download content may have a predetermined lifespan in the user's computer storage and may be deleted at the expiration of the predetermined lifespan. The predictive download material may also be subject to deletion by the user without viewing. The predictive download targeted advertisement may have a separate lifespan as determined by the organizations that supplied the advertisements so that materials associated with advertising campaigns expire concurrently with the campaigns.

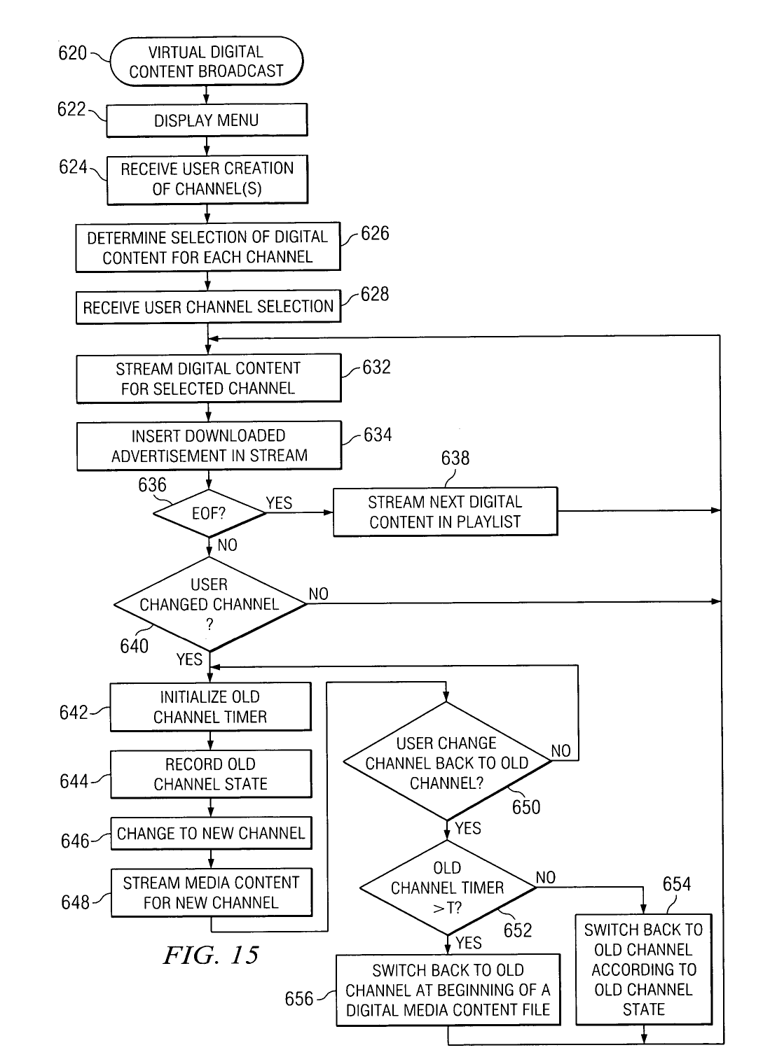

FIG. 15 is a simplified flowchart of a virtual digital content broadcast process 620 according to an embodiment of the present invention. Process 620 is used to simulate a digital broadcast of a plurality of channels using digital media content 27 that was previously downloaded or streamed to a station communicably coupled to a tuner or digital media player 12, an example of which is shown in FIG. 1. The downloaded digital media content 27 is stored in memory storage 28 of station 52 and shown or played on the entertainment and sound system 14 in a virtual broadcast. Process 620 may operate in conjunction with predictive download process 580 shown in FIG. 15 and described above. Although virtual digital content broadcast process 620 is intended to simulate a broadcast, certain characteristics of a broadcast system is altered to improve its user-friendliness. For example, if the user has been viewing a program and changes the channel selection to a different channel mid-program, but returns to the original channel after a brief time, then the original channel resumes streaming at the point where the user had briefly changed the channel, rather than at some time later or at the beginning of the program. This way, the user does not miss any portion of the show or need to find the location where he stopped viewing the program. However, if the user was viewing a program on a selected channel only briefly, then changes the channel, process 620 does not make an effort to note the point at which the user changed the channel. Process 620 in accordance with an embodiment is described in more detail below.

In block 622, a menu is displayed to the user to enable the user to create one or more channels of one or more media types or categories. The user's input to create the channels and the digital media content selections is received, as shown in blocks 624 and 626. For example, the user may choose to create three music channels for rock, classical, and jazz music types, a video channel for action movies, a video channel for family-appropriate movies, and a channel for game shows. Alternatively, the user may create a channel just for Elvis' music, or a channel just for movies starring Katherine Hepburn, for example. After the channels are set up, the user may provide an input to indicate a channel selection, as shown in block 628. The digital media content 27 having meta data matching the specification for the selected channel is then streamed in a simulated broadcast for the user, as shown in block 632. In general, any information typically contained in the meta data of the digital media content 27 may be used to create a channel, such as particular actor/artist, title including a particular word or phrase, type of media content, classification of media content, etc. At appropriate intervals, one or more previously-downloaded targeted advertisement spots are inserted into the simulated broadcast and shown or played to the user, as shown in block 634.

In block 636, the current digital media content selection file is checked to determine whether the end of the file has been reached. If the end of the file has been reached, then the next digital media content selection for the current channel is streamed to digital media player 12 for showing or playing to the user on the television set or sound system, as shown in block 638. If the end of the file has not been reached, a determination is also made as to whether the user has provided an input such as changing the channel selection, as shown in block 640. Although not shown herein, the user may also make other inputs such as pause, replay, rewind, fast forward, which enable the user to manipulate the current location within the current digital media content file. If the user has not made a channel change, then the current digital media content selection streaming is continued in block 632.

If the user changes the channel selection, as determined in block 640, then a channel timer is initialized for the old channel and the state of the old channel is recorded, as shown in blocks 642 and 644. The channel is then changed to the one selected by the user and digital media content for the new channel is streamed for display, as shown in blocks 646 and 648. If the user once again changed the channel to the old channel, as determined in block 650, then the channel timer for the old channel is compared with a predetermined time, T, as shown in block 652. If the channel timer is not greater than T, then the channel is switched back to the original channel according to the recorded state of the old channel, as shown in block 654. This means that if the user changed the channel previously from the old channel in the middle of a show, and only lingered at the new channel for a time less than T, then the user is returned to the channel at the same point in the show. Otherwise if the old channel timer is greater than T, then the channel is switched back to the old channel at the beginning of a digital media content file, as shown in block 656. Therefore, if the user had lingered for a longer period of time, such as time greater than T, then it is as if the user has not really viewed any show in the old channel, and the recorded state of the old channel is discarded or not used when the user is returned to that channel again. If in block 650 it is determined that the user switched to some channel other than the original channel, a channel timer is set for the channel that the user was on and records the state of the channel, as shown in blocks 642 and 644, before switching to the next channel. The time value T may be selected by studying the viewing preferences or viewing patterns of television broadcast viewers, or T may be set by each user to his/her own preferences.

It may be seen that the virtual digital content broadcast process described above differs from conventional broadcast systems. Conventional broadcasts do not track the progress of any user, it merely multicasts the content and advertisement for each channel and continues to stream the content. If a conventional system user tunes in to a particular channel, changes the channel, and then changes back to the original channel within a short time period, the user will have missed content that was broadcasted during that time period. In contrast, the process described above resumes “broadcast” at an appropriate point in the show or song where the user left off, so that nothing is missed.

The user may also employ dynamic and/or static filtering to further tailor the streamed content. Dynamic filters are applied in real time, while digital media content 27 is being streamed to the digital media player 12. Static filters may be used to define what kind of digital media content 27 is downloaded to the user's computer system 26 or the digital media player 12. The filtering criteria can be based on the meta data of the digital media content 27. Because the present system only needs to please a single user, it can determine a minimal interval before the same selection, such as a song, can be repeated in the play list. Also, newer content may be a higher priority for inclusion in the play list than older content.

The user may further influence the digital media content 27 that is streamed to his system by giving feedback on the current digital media content 27 being experienced. For example, the user may use a dedicated key on control pad 22 or remote control 20 to indicate whether he likes or dislikes that particular digital media content 27. A negative rating would reduce the likelihood that the selection or episodes in the same selection will be shown or played again. A positive rating would cause the selection or episodes in the same selection to be shown or played more frequently or consistently than selections with lower ratings. A very strong positive rating would cause the selection to remain on the play list for a longer period of time than other selections. The ratings may also be cached and reported to server 52, where they can be used to provide statistical feedback to the content owners and shape the selection of content for future downloads. Unlike other meta data, user ratings may have a decay parameter associated therewith. The user ratings decay slowly over time and may eventually cease to affect the selection of digital media content. This feature enables the present system to adapt to changing user preferences over time.

It may be seen that the present invention provides a convenient and easy-to-use bridge between the computer and the entertainment system, and further between the Internet and the entertainment system, so that digital media materials may be viewed and heard in a more optimal video and audio environment. Furthermore, the users have control over the time and which digital media content he/she views. This high-level of interactivity is heretofore difficult and costly to implement and deploy within the current broadcast, cable and satellite content delivery systems.

Although the present invention and its advantages have been described in detail, it should be understood that various changes, substitutions, and alterations can be made therein without departing from the spirit and scope of the present invention as defined by the appended claims.

What is claimed is:

1. A digital media system, comprising:
a computer having a local storage device operable to store a plurality of driver applications and being operable to access a remote storage device having stored digital media content via a global computer network; and
a digital media player communicably coupled to the computer and operable to access the plurality of driver applications and further operable to receive user commands and access and decode the remote digital media content specified by the user for playing on one or more components of an entertainment system coupled thereto.

2. The system, as set forth in claim 1, wherein the digital media player is communicably coupled to the computer via a communication link selected from the group consisting of a global computer network, a local area network, and a wireless network.

3. The system, as set forth in claim 1, wherein the digital media player further comprises a removable storage media player operable to read a removable storage media.

4. The system, as set forth in claim 1, wherein the removable storage media player is also operable to write data to the removable storage media.

5. The system, as set forth in claim 1, wherein the digital media player is operable to display a menu having a plurality of menu items on a television set coupled thereto, and further operable to receive user selections of menu items.

6. The system, as set forth in claim 5, wherein the menu items represent the digital media content.

7. The system, as set forth in claim 1, wherein the digital media player comprises a game console selected from the group consisting of a PLAYSTATION game console, a GAMECUBE game console, and an XBOX game console.

8. The system, as set forth in claim 1, wherein the digital media player has stored thereon computer software operable to perform authentication between the computer and the remote storage device.

9. The system, as set forth in claim 1, wherein the remote storage device operates to encrypt the digital media content selected by a user and communicate the encrypted digital media content to the digital media player where it is decrypted prior to be decoded and played on one or more components of the entertainment system.

10. The system, as set forth in claim 9, wherein the remote storage device also operates to collect and process billing information prior to encrypting the digital media content.

11. A digital media system, comprising:
a content provider having a collection of digital media content;
a computer system having a storage media having encoded thereon a plurality of driver applications; and
a digital media player communicably coupled to the computer system and the content provider via a global computer network and operable to receive user commands instructing the content provider to stream digital media content specified by the user to the digital media player for decoding using a driver application and playing on one or more components of an entertainment system coupled to the digital media player.

12. The system, as set forth in claim 11, wherein the digital media player further comprises a removable storage media reader operable to read a removable storage media.

13. The system, as set forth in claim 12, wherein the removable storage media reader is also operable to write data to the removable storage media.

14. The system, as set forth in claim 11, wherein the content provider operates to encrypt the digital media content selected by a user and communicate the encrypted digital media content to the digital media player where it is decrypted prior to be decoded and played on one or more components of the entertainment system.

15. The system, as set forth in claim 14, wherein the digital media player is also operable to store data encryption keys received from the content provider to be used to decrypt encrypted digital media content received from the content provider.

16. The system, as set forth in claim 14, wherein the content provider also operates to collect and process billing information prior to encrypting the digital media content.

17. The system, as set forth in claim 11, wherein the digital media player is operable to display a menu having a plurality of menu items on a television set coupled thereto, and further operable to receive user selections of menu items.

18. The system, as set forth in claim 17, wherein the menu items represent the digital media content.

19. The system, as set forth in claim 17, wherein the menu items represent entertainment channels, each entertainment channel having a collection of digital media content.

20. The system, as set forth in claim 17, wherein the menu items represent entertainment channels, each entertainment channel having a sequential stream of digital media content.

21. The system, as set forth in claim 1, wherein the digital media player comprises a game console selected from the group consisting of a PLAYSTATION game console, a GAMECUBE game console and an XBOX game console.

22. A method, comprising:
displaying, on a television, a list of digital media content stored in a remote database;
receiving, at a digital media player coupled to the television, a digital media content selection from the list from a user;
streaming the digital media content selection stored in the database over a global computer network;
buffering the streaming digital media content selection as it is received at the digital media player; and
sending the buffered digital media content selection to the television for displaying to the user.

23. The method, as set forth in claim 22, further comprising:
retrieving media driver updates from a media server over the global computer network; and
decoding the streaming digital media content selection with one of the media driver updates.

24. The method, as set forth in claim 23, further comprising:
sending a unique identifier to a media server for verification;
sending data associated with the user to the media server;
receiving a public key having a private key associated therewith;
receiving software updates encrypted with the private key from the media driver; and
decrypting the received software updates with the public key.

25. The method, as set forth in claim 21, wherein displaying a list of digital media content comprises displaying a list of digital images, video and audio content.
